(19) United States
(12) Patent Application Publication
(10) Pub. No.: US 2007/0151118 A1
(43) Pub. Date: Jul. 5, 2007

(54) Device for radiation drying

(76) Inventor: Luciano Perego, Mezzago (Milan) (IT)

Correspondence Address: PEARNE & GORDON LLP, 1801 EAST 9TH STREET, SUITE 1200, CLEVELAND, OH, 44114-3108, US

(21) Appl. No.: 11/639,723

(22) Filed: Dec. 15, 2006

(30) Foreign Application Priority Data
Dec. 22, 2005 (EP) 05425907.2

(51) Int. Cl. F26B 3/34

(52) U.S. Cl. 34/275; 34/278; 34/277

(57) ABSTRACT

A drying device, preferably of the UV light type, for articles printed by ink laying, comprises at least one lamp (2) radiating a UV light beam, and at least one opening screen (8) interposed between the lamp (2) and the printed articles (3) to be dried, to alternately intercept the UV light beam. The opening screen (8) is further provided with a liquid cooling plant (12).

The present invention relates to a device for radiation drying.

In particular, the present invention specifically applies to the step of drying printed articles in which specific inks are used, particularly in ink-jet printing apparatus.

Preferably, the present invention relates to ultraviolet-radiation (UV) drying devices.

It is known that a great number of the ink-jet printing apparatus use UV-radiation devices for drying articles on which ink has been laid.

The ink-jet printing apparatus presently on the market are provided with print heads whose task is to pick up the ink from a tank and dispose it at a predetermined speed onto the article to be printed in an amount and following modalities depending on the printing operation to be carried out.

The UV-radiation technology is increasingly more often used in all sectors of the graphic industry and in the sectors involving quality printing processes to be made quickly and in successive passages. There is a widespread use of UV light lamps as a drying device in a wide range of fields including polymerisation of the printing inks and coatings, applications for wood, plastic, paper and glass finish or for metal decorations, optical fibres, CD or DVD production and electronic devices.

Due to quick drying and durable brightness of the printed ink, the final article can be immediately used or piled up for storage and/or transport.

The process for example applies when paperboard and corrugated cardboard are to be printed and includes printing on packages for medical and food articles, labels, plastic materials, sheet metals or safety cards such as banknotes or credit cards.

Inks drying through exposure to UV radiation consist of liquid components such as polyfunctional epoxy resins containing reactive acrylates, additives, colouring agents and photocatalysts that cross-link to form a dry and hard film under the action of a UV radiation source.

There are different types of UV lamps; the two most used ones are the high-pressure mercury-arc lamps and low pressure lamps.

The UV lamps of the high pressure and mercury-arc type are generally built in the form of a tube and are not very long.

To keep a correct operation, a water flow maintaining the operating temperature constant is required for these lamps. In particular, the lamps are provided with a cooling plant surrounding them and adapted to draw the excess heat generated by the lamps themselves. In this way the lifetime of the lamp can be increased.

During the step in which the articles are not present under the drying device, the lamps are closed by an opening screen preventing the UV radiation from being reflected to the outside, which would cause even serious trouble to the operators and would affect the performance of the print heads. In fact, if the emitted UV radiation impinges on the print heads for an excessive period of time, it can dry the nozzles thereby impairing the print quality, and sometimes even damaging the heads themselves in an irreparable manner.

However, since the light emitted from said lamps is highly energetic, the opening screen and the other surfaces coming into contact with said radiation are overheated causing deformations and malfunctions.

To avoid these drawbacks, provision of a cooling plant for the surfaces that are exposed to said UV radiation for an extended period of time is required.

It is known that a commonly adopted technique to solve this problem consists in using a cold air flow directly blown on the surfaces to be cooled for removal of the excess heat.

Disadvantageously, this solution is weakly efficient since an air flow can hardly reach all points of the overheated surfaces.

In addition, UV-radiation drying devices of the above described type are characterised by an important bulkiness, exactly due to the sizes of the cooling plant. In fact, use of an air flow involves the presence of fans of an important diameter. Furthermore, the air flow interacts with the ink jet emitted from the heads and impairs the print quality and accuracy. Finally, during operation, the fans generate a strong noise resulting in trouble for the operators working in the vicinity of said fans.

The Applicant has found that devices for radiation drying of the above described type can be improved under different points of view, in particular as regards efficiency and bulkiness of same.

It is an aim of the present invention to obviate the above drawbacks, by providing a radiation-drying device provided with a plant for cooling the (movable or fixed) surfaces that are impinged on by the emitted radiation.

In addition, it is a further aim of the invention to provide a cooling plant that is greatly more efficient and compact than those present in commonly used techniques.

In accordance with the present invention, this aim is achieved by a radiation-drying device having the features recited in claim 1 and, preferably, in anyone of the following claims directly or indirectly depending on said claim 1.

The present invention will be now described with reference to the accompanying drawings, depicting a preferred, but not exclusive, embodiment of a radiation-drying device, in which:

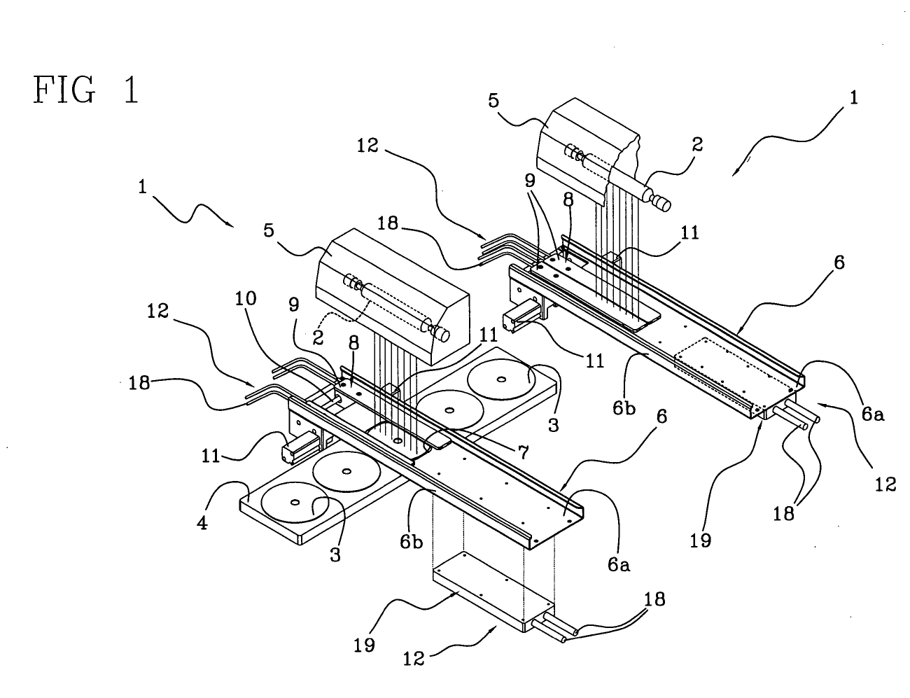

FIG. 1 diagrammatically shows an overall view of two of said devices, in a perspective view;

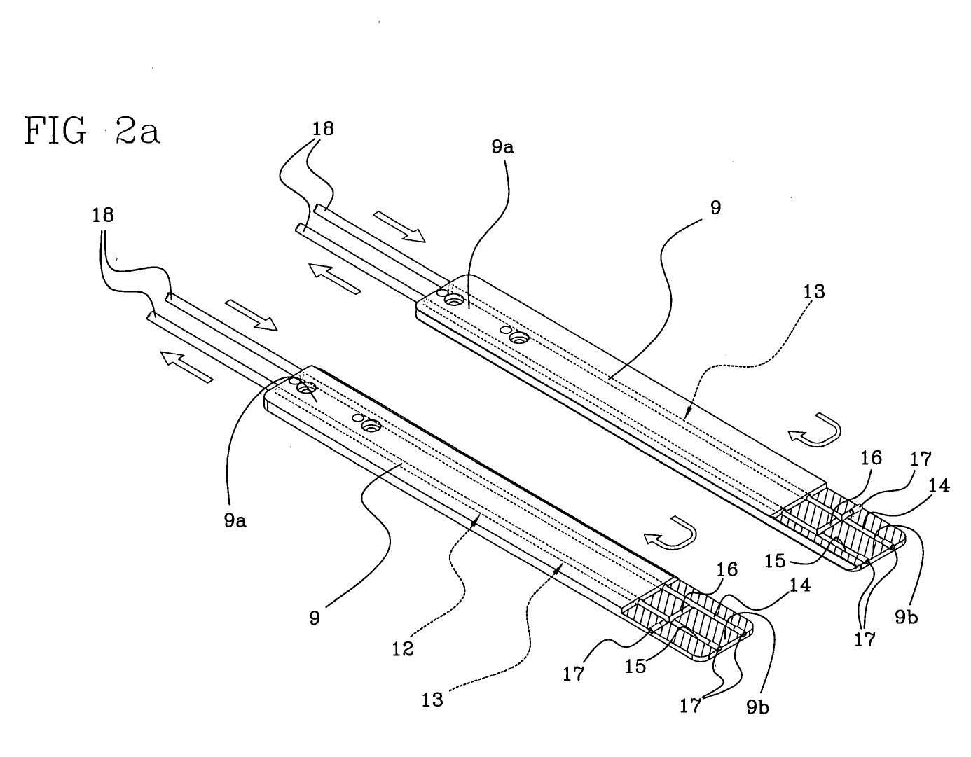

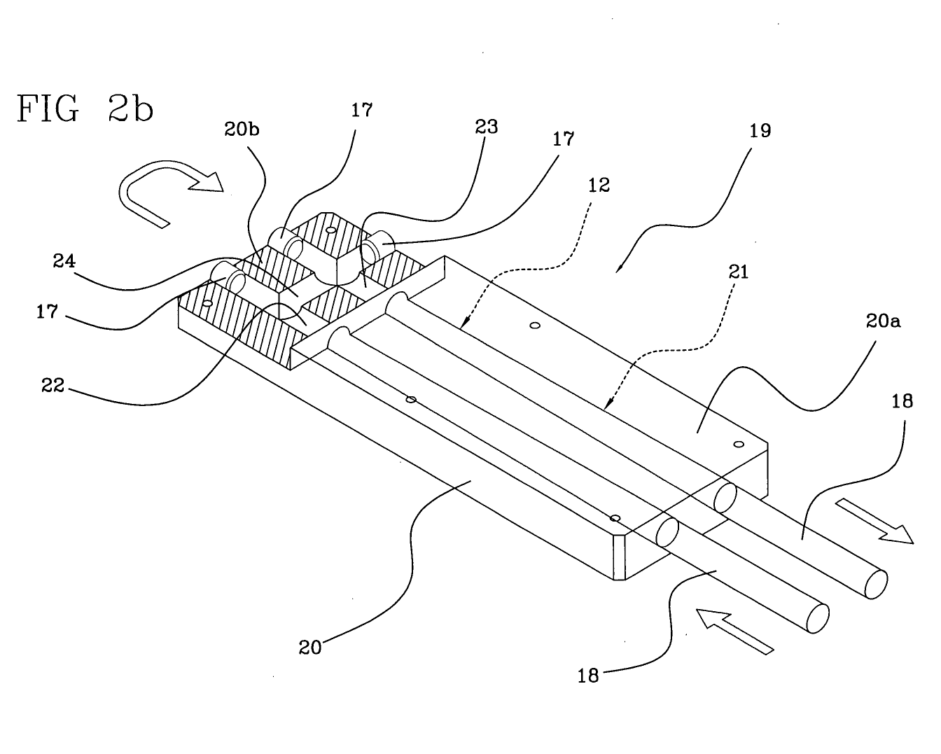

FIG. 2a shows a first detail of the devices seen in FIG. 1;

FIG. 2b shows a second detail of the devices seen in FIG. 1;

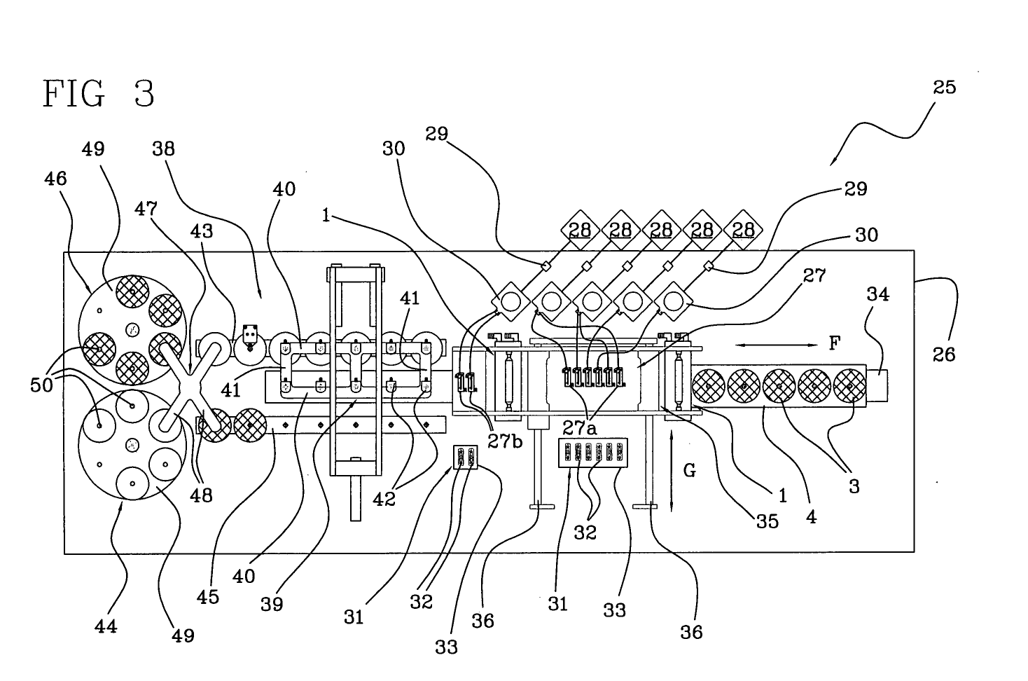

FIG. 3 is a diagrammatic top view of an ink-jet printing apparatus provided with the two devices shown in FIG. 1.

With reference to the drawings, a device for radiation drying comprising at least one lamp 2, preferably but not exclusively a UV light lamp, has been generally identified by reference numeral 1.

In the example in FIG. 1, two of said devices 1 are mounted on an ink-jet printing apparatus electronically controlled by a processor. In this apparatus, a plurality of articles 3 is laid on a support or tray 4 driven in relative motion with respect to the drying device 1.

In ink-jet printing apparatus of the traditional type, the support 4 is fixed, whereas the whole drying device 1 is slidably movable along a printing and drying direction “F”.

Alternatively, as shown in this example, the support 4 is slidably movable along the printing and drying direction “F” and the drying device 1 is mounted on a fixed supporting structure (not shown). In more detail, the support 4 defines a reciprocating motion along the direction “F” so as to repeatedly bring the articles 3 below the print heads and the lamps 2, to enable printing, i.e. laying of the ink, and full drying of the article 3 in several steps.

The lamps 2 are disposed with the respective main extension axis at right angles to the direction “F”. Said lamps 2 are enclosed into respective lamp-holding boxes 5 inside which, in addition, a cooling liquid flows to remove the excess heat generated by the lamps 2. To this aim, lamps 2 are fully surrounded by, and/or dipped in this liquid. Preferably, but not exclusively, the cooling liquid consists of water.

The drying device 1 further comprises a plate-like structure 6 put under each lamp 2. This plate-like structure has a base 6a of essentially elongated rectangular shape and flaps 6b along the major sides which are folded in a “C” configuration.

The plate-like structure 6 has the function of closing each lamp-holding box 5 at the lower part thereof. In FIG. 1, the lamp-holding boxes 5 are represented spaced apart from the supporting structure 6 for the sake of clarity. Actually, a lower end of each box 5 lies between the two C-folded sides preventing lateral escape of the UV radiation. The lamp 2 is therefore very close to the articles 3 to be dried, so that the emitted radiation can reach the articles 3 almost completely and the amount of power lost is minimised.

A window 7 is formed on the base 6a of each supporting structure 6, at the region along which the support 4 with the articles 3 carried thereon travels, so that the UV light beam is enabled to impinge on the articles 3 themselves. The shape of the window 7 essentially depends on the shape of the articles 3. In the embodiment shown, in which articles 3 consist of discs, such as CD's and DVD's, the window 7 is substantially of rectangular shape.

Since during the printing and drying process there are work steps during which the articles are not disposed under the drying devices 1 and therefore said drying devices 1 operate to no purpose, it is suitable to prevent said UV light beam from impinging on the print heads during said steps. In fact, an impact of the radiation against the head nozzles for long periods of time and in great amounts surely damages said nozzles. To this aim, the window 7 is provided with an opening screen 8. This opening screen 8 comprises at least one movable wall. In the example under discussion, the screen 8 comprises two movable walls 9 of elongated rectangular shape. These walls are shiftable close to or away from each other.

In more detail, the walls 9 are movable between a first position at which the window 7 is closed and the UV light beam is intercepted, and a second position at which the window 7 is open and the UV light beam can impinge on the underlying articles 3.

The movable walls 9 slide along a straight bar 10 and on the base 6a of the plate-like supporting structure 6. Movement of said walls is preferably ensured by a respective linear actuator 11, of the pneumatic type for example.

The drying device 1 advantageously comprises a liquid cooling plant 12 integrated into the movable walls 9 of the screen 8. In fact, at the inside of each wall 9 ducts 13 are formed along which the cooling liquid flows.

In the preferred embodiment herein depicted, the ducts 13 consist of a first hole 14 and a second hole 15; they are both through holes and are parallel to each other. Said holes 14, 15 extend from a first end 9a of each wall to a second end 9b, opposite to the first one 9a. In addition, a third hole 16 is made perpendicular to the first 14 and second 15 holes. The third hole 16 passes through the first hole 14 and opens into the second hole 15. The third hole 16 is made close to the second end 9b of each wall 9. The outlet of the third hole 16 and the outlets of the first 14 and second 15 holes in the vicinity of the second end 9b of each wall 9 are closed by means of plugs 17. In this manner, a U-shaped pipe coil is obtained. The pipe coil could in any case have a different shape, depending each time on the specific requirements.

Connected to the outlets of the first 14 and second 15 holes are pipes 18 defining the coil delivery side and return side and they are connected to other components of the cooling plant not shown, such as a radiator and a pump for example.

The cooling plant further comprises a heat exchanger 19 placed under the base 6a of each plate-like structure 6 and disposed in side by side relationship with the window 7.

The heat exchanger 19 comprises a plate 20 of substantially rectangular shape. A face 20a of each plate 20 is put into contact with the base 6a of the supporting structure 6.

Formed within the plate 20 are ducts 21 similar to those formed in each movable wall 9. In detail, said ducts 21 have a first 22 and a second 23 holes, consisting both of mutually parallel through holes, and a third hole 24 perpendicular to the first 22 and second 23 holes.

The third hole 24 passes through the first hole 22 and opens into the second one 23. The outlets of the third hole 24 and those of the first hole 22 and the second hole 23 placed at one end 20b of plate 20 are closed by plugs 17. In this manner a U-shaped pipe coil is obtained that is quite similar to that of the movable walls 9. This pipe coil too could in any case have a different shape, depending each time on the specific requirements.

Further pipes 18 are connected to the plate 20 of the heat exchanger 19 to move away and cool the liquid.

The cooling liquid therefore runs in the ducts 13 of the movable walls 9 and in the ducts 21 of the heat exchanger 19, drawing the heat produced by the UV light beam impacting against the metal surfaces of the drying device 1.

The cooling liquid typically consists of water. However, also other types of liquids can be used. In fact, should a power increase be required in the UV lamps, there would be too much heat to be removed and water would not be sufficient any longer. In this case, liquids characterised by a boiling temperature higher than 100° C. are used.

Alternatively, the water can be maintained to a higher pressure than the atmospheric one so as to increase its boiling temperature.

The drying device 1 is advantageously mounted on an ink-jet printing apparatus 25 to print articles 3 preferably but not exclusively made of plastic material (FIG. 3) such as CD's or DVD's.

In the described embodiment, apparatus 25 comprises two drying devices 1 both mounted on a base 26 of the apparatus 25 itself.

This printing apparatus 25 comprises at least one print head 27a, 27b for each colour used. In the example herein described, the printing apparatus 25 involves a four-colour process and therefore on the whole uses five inks of different colours (black, magenta, cyan, yellow and a colour designed to constitute a background such as white). It is therefore possible for an ink to feed more than one head.

In more detail, the present printing apparatus 25 comprises six main print heads 27a for a four-colour printing process and two further auxiliary heads 27b for printing of the background.

The printing apparatus 25 further comprises an ink-containing tank 28 connected to a metering device 30 by means of a regulating valve 29. The metering device 30 is connected to the print head or heads 27a, 27b.

The printing apparatus 25 further comprises a cleaning device 31 for the print heads 27a, 27b. This device 31 comprises a plurality of suction openings 32 associated with each head 27a, 27b. The suction openings 32 are mounted on supporting plates 33. The plates 33 are movable in a substantially vertical direction so that the suction openings 32 can be reached by the heads 27a, 27b.

The articles 3 to be printed lie on a support 4 movable in a reciprocating motion in the printing direction “F”. The support 4 is positioned along a central straight guide 34 extending in the longitudinal extension of the printing apparatus 25 and is fastened to the base 26. The support 4 is moved by a suitable linear motor (not shown).

The print heads 27a, 27b are housed on a carriage 35 movable in a direction “G” perpendicular to the printing direction “F” along suitable parallel slides 36.

More specifically, all heads 27a, 27b are aligned in parallel to the printing direction “F”. The main heads 27a intended for a four-colour printing process, are out of alignment relative to the auxiliary heads 27b reserved for printing of the background so that, during each passage of articles 3 under the heads 27a, 27b, the background-ink band is translated relative to that of the coloured ink. In other words, the coloured-ink band does not fully cover the background-ink band, so as to prevent the coloured ink from being directly laid on articles 3 without previous laying of the background.

The printing apparatus 25 comprises two UV light drying devices 1. Said devices 1 are mounted on the base 26 of the printing apparatus 25 and in particular they are mounted under the carriage 35 housing the heads 27.

In more detail, the plate-like structure 6 of each of the devices 2 is integral with the base 26 and placed on the support 4 while the lamp-holding box 5 is integral with the carriage 35 and moves with the latter along the direction “G” perpendicular to the printing direction “F”. The box 5 therefore slides on the plate-like structure 6 and between the C-folded flaps 6b. In this way the lamp 2 follows the heads 27a, 27b so as to keep its central position emitting the maximum radiation amount exactly on the just printed region to be dried. When the box 5 is on the window 7 and irradiates the movable walls 9, most of the produced heat is eliminated by the liquid running in ducts 13, whereas when the box 5 moves towards the heat exchanger 19 and irradiates the overlying plate-like structure 6, elimination of the greatest amount of the produced heat is carried out by the liquid contained in ducts 21 of said heat exchanger 19.

In accordance with an alternative embodiment not shown, the box 5 is fixed and integral with the plate-like structure 6 mounted on the base 26. In this embodiment, the central portion of lamp 2 is long enough to cover the whole path of the heads 27a, 27b in the direction “G” perpendicular to the printing direction “F”.

The first drying device 1 is mounted between the main heads 27a and the auxiliary heads 27b. The function of this device is mainly to dry the background ink layer disposed on articles 3.

The second device drying 1 is mounted to a position opposite to the first device with respect to the main heads 27a and its task is to dry the coloured ink layer laid on the background.

Articles 3 are loaded and unloaded from support 4 by suitable handling means 38 that preferably comprises a movable frame 39. The movable frame 39 is made up of two parallel bars 40 joined together by a plurality of crosspieces 41. Disposed along said bars 40 is suitable grip means 42 preferably although not exclusively consisting of suction outlets.

The printing apparatus 25 further comprises a first loading conveyor belt 43 connected to a first loading magazine 44 containing the articles 3 to be printed, i.e. on which ink is to be laid, and a second unloading conveyor belt 45 connected to a second unloading magazine 46 into which the already printed articles 3 are stored.

Extending between the loading conveyor belt 43 and the unloading conveyor belt 45 is said linear guide 34 so that the support 4 can be brought to an intermediate position between the loading conveyor belt 43 and the unloading conveyor belt 45.

Said frame 39 is movable in a horizontal direction between a first position, at which one of the bars 40 is in superposed relationship with the loading belt 43 and a second position at which the other bar 40 is in superposed relationship with the unloading belt 45. The frame 39 is also movable in a vertical direction between a raised position and a lowered position.

In the loading and unloading steps, the frame 39 takes up the first horizontal position, so that one bar 40 is on the articles 3 to be printed and disposed on the loading belt 43 and the other bar 40 is on the printed articles 3 laid on the support 4.

The movable frame 39 moves downwards and the grip means 42 is actuated to grasp the articles 3 that are raised simultaneously with frame 39.

Subsequently, the frame 39 is shifted to the second horizontal position at which the bar 40 carrying the articles 3 to be printed is over the support 4, and the bar 40 carrying the printed articles 3 is over the unloading conveyor belt 45.

Finally, the frame 39 moves downwards and deactivation of the grip means 42 occurs. In this way, the articles 3 to be printed lie on the support 4 and the printed articles 3 lie on the unloading conveyor belt 45.

Said handling means 38 further comprises a cross structure 47 ensuring connection between the magazines 44, 46 and the conveyor belts 43, 45. The cross structure 47 is provided with grip means (not shown in the figures) that generally consists of suction outlets. The cross structure 47 is movable in a vertical direction and is driven in rotation about its substantially vertical axis due to a respective motor, not shown. The cross structure 47 is provided with four arms 48 and carries out loading and unloading of the articles onto and from the conveyor belts 43, 45. First of all, the cross structure 47 by the grip means, grasps a printed article 3 from the unloading conveyor belt 45 and an article to be printed 3 from the loading magazine 44. After a 180° rotation, the cross structure 47 releases the article to be printed 3 onto the loading conveyor belt 43 and the printed article 3 into the unloading magazine 49. Simultaneously, the cross structure 47 grasps a printed article 3 again from the unloading conveyor belt 45 and an article to be printed 3 from the loading magazine 44.

The loading magazine 44 and unloading magazine 45 each comprise a revolving plate 49 provided with a plurality of seats adapted to carry the articles 3. In the specific example, said articles 3 consist of optically readable discs such as CD's or DVD's and the necessary seats to carry them are defined by vertical rods 50.

The present invention achieves the intended purposes and has important advantages.

First of all, the liquid cooling plant 12 mounted in the drying device 1 is more efficient in removing the heat generated by an interaction of the UV light beam with the metal walls. Therefore, the UV light lamps can be maintained switched on, the screen walls being closed, also during short servicing interventions, without being obliged to actuate them again and wait for heating of same before restarting working. Therefore, the time and amount of the radiation impinging on the print heads can be reduced, which will result in an increase in the lifetime of the heads and an improvement in the print quality.

In addition, the liquid cooling plant 12 enables use of fans of big sizes to be avoided for generating the necessary air flow. The cooling plant 12 is therefore more compact and consequently the drying device 1 and printing apparatus 25 on which it is mounted are characterised by a reduced bulkiness. Since there is no air flow impinging on the ink emitted from the heads, the print quality is excellent. Furthermore, due to the absence of fans, the drying device 1 is much more noiseless and the trouble of the operators working in the vicinity of the printing apparatus 25 is practically eliminated.

Finally, since in the cooling plant 12 also liquids other than water can be used in order to be able to eliminate bigger heat amounts, the device 1 is very versatile, as it is adapted for different operating conditions.

1. A device for radiation drying, comprising at least one lamp (2) emitting a radiation beam, and at least one opening screen (8) interposed between said lamp (2) and the printed articles (3) to be dried, to alternately intercept the radiation beam, wherein said opening screen (8) further comprises a liquid cooling plant (12).

2. A device as claimed in claim 1, wherein said opening screen (8) comprises at least one movable wall (9).

3. A device as claimed in claim 2, wherein said liquid cooling plant (12) has a duct (13) internal to said movable wall (9) for passage of a cooling liquid.

4. A device as claimed in claim 2, wherein said opening screen (8) further comprises a plate-like structure (6).

5. A device as claimed in claim 4, wherein said liquid cooling plant (12) further comprises a heat exchanger (19) put into contact with said plate-like structure.

6. A device as claimed in claim 5, wherein said heat exchanger (19) comprises a plate (20) provided with an internal duct (21) for passage of a cooling liquid.

7. A device as claimed in claim 4, wherein said plate-like structure (6) has a window (7) in register with a printed article (3), so that only the printed article (3) to be dried is exposed to the lamp (2) light.

8. A device as claimed in claim 7, wherein said movable wall (9) is positioned on said window (7).

9. A device as claimed in claim 7, wherein said movable wall (9) is slidable on said plate-like structure (6) between a first position at which said movable wall (9) closes said window (7) and intercepts the radiation beam, and a second position at which said movable wall (9) opens said window (7) enabling the radiation beam to pass therethrough and impinge on the article (3) to be dried.

10. A device as claimed in claim 1, wherein said opening screen (8) comprises two movable walls (9) slidable in the same plane and moving close to or away from each other.

11. A device as claimed in claim 1, wherein said lamp (2) is provided with a liquid cooling plant.

12. A device as claimed in claim 7, wherein said lamp (2) is contained in a lamp-holding box (5) with an open side to irradiate the articles (3).

13. A device as claimed in claim 12, wherein said box (5) is slidable on the plate-like structure (6) between a position close to the window (7) and a position close to a heat exchanger (19) disposed in side by side relationship with the window (7) and in contact with said plate-like structure (6).

14. A device as claimed in claim 1, wherein said cooling liquid is water.

15. A device as claimed in claim 1, wherein said radiation is an ultraviolet radiation.

16. An ink-jet printing apparatus, comprising at least one device for radiation drying as claimed in claim 1.

17. An ink-jet printing apparatus as claimed in claim 16, wherein it further comprises a base (26), a support (4) movable in a printing direction (F) and carrying the articles (3) to be printed, a carriage (35) movable in a direction (G) perpendicular to the printing direction (F), at least one print head (27a, 27b) mounted on the carriage (35); said drying device (1) being placed alongside said head (27a, 27b).

18. A printing apparatus as claimed in claim 16, wherein it comprises two drying devices (1).

19. A printing apparatus as claimed in claim 18, wherein said drying devices (1) are placed on the respective sides of said head (27a).

20. A printing apparatus as claimed in claim 17, wherein said opening screen (8) comprises at least one movable wall (9), wherein said opening screen (8) further comprises a plate-like structure (6), wherein said plate-like structure (6) has a window (7) in register with a printed article (3), so that only the printed article (3) to be dried is exposed to the lamp (2) light, wherein said lamp (2) is contained in a lamp-holding box (5) with an open side to irradiate the articles (3), wherein said box (5) is slidable on the plate-like structure (6) between a position close to the window (7) and a position close to a heat exchanger (19) disposed in side by side relationship with the window (7) and in contact with said plate-like structure (6), wherein the box (5) of said at least one drying device (1) is integral with the carriage (35), and the plate-like structure (6) is integral with the base (26) and superposed on the support (4).
